(19) United States
(12) Patent Application Publication
(10) Pub. No.: US 2008/0166681 A1
(43) Pub. Date: Jul. 10, 2008

(54) Apparatuses for dental implantation and methods for using same

(75) Inventors: Uriel Weinstein, Mazkeret Batia (IL); Assaf Bernstein, Givat Nili (IL); Vered Cohen Sharvit, Jerusalem (IL); Michal Shohat, Rechovot (IL); Yuval Yohai, Rechovot (IL); Noa Graf, Tel-Aviv (IL); Ronen Eldar, MaAle Adumim (IL); Tatyana Zaslavsky, Jerusalem (IL)

Correspondence Address: Martin D. Moynihan;PRTSI, Inc., P.O. Box 16446, Arlington, VA, 22215, US

(73) Assignee: Tactile Technologies LLC, Las Vegas, NV (US)

(21) Appl. No.: 12/003,935

(22) Filed: Jan. 3, 2008

Related U.S. Application Data
(60) Provisional application No. 60/883,367, filed on Jan. 4, 2007.

(51) Int. Cl. A61C 3/02

(52) U.S. Cl. 433/76

(57) ABSTRACT

A template for performing a dental implantation procedure, comprising: a main body adapted to seat on a plurality of oral structures, and at least one mounting point on the main body for mounting at least one drill guide, wherein the main body is provided with exposed implantation spaces where the dental implantation is to be performed.

### RELATED APPLICATIONS

The present application claims benefit under 119(e) of U.S. provisional patent application 60/883,367, filed Jan. 4, 2007, the disclosure of which is incorporated herein by reference. The present application is related to PCT Application No. PCT/IL2004/000069, filed on Jan. 23, 2004 and entitled “Dental Tool Guides” and to U.S. application Ser. No. 10/543,034, filed on Jul. 21, 2005 also entitled “Dental Tool Guides”, the disclosures of which are incorporated herein by reference.

### FIELD OF THE INVENTION

The present invention relates to apparatuses for performing dental implantation and/or oral surgery, including dental templates, drill guides, drill guide manipulators, and methods for making and/or using them.

### BACKGROUND OF THE INVENTION

Proper alignment and placement of dental implants during implantation procedures are important for successful implantation. Numerous aids have been provided to medical professionals for ensuring proper alignment and placement.

For example, U.S. Pat. No. 7,104,795 to Dadi, the disclosure of which is incorporated herein by reference, describes an accessory for use in aiding an oral surgeon to determine the optimum position and angle for a dental implant to be installed in a bone including a probe assembly having one or more pairs of probe members pivotally mounted to each other about a pivot axis at their centers. Each pair of probe members is configured and dimensioned such that one end of the pair on one side of the pivot axis serves as a probe end to straddle the bone with their tips contacting the bone at opposed contact points thereon, and the opposite end of the pair on the opposite side of the pivot axis serves as a guide end in which the tips of the probe members are automatically located to indicate the thickness of the bone at the pair of opposed contact points. Also described are a kit including a plurality of such accessories, a tool for manually applying such accessories, and a method of using such accessories for use in determining the optimum position and angle for a dental implant.

In addition, companies such as Nobel Biocare have developed software and/or apparatuses for assisting medical professionals, such as the NobelGuide™ and the Teeth-in-an-Hour™ products, the disclosures of which are incorporated herein by reference. Other developments include the SimPlant Surgiguide product of Materialise NV, the disclosure of which is incorporated herein by reference.

### SUMMARY OF THE INVENTION

An aspect of some embodiments of the invention relates to providing customized dental templates for performing dental implantation which seat on a plurality of oral structures and which is provided with at least one exposed implantation space. It should be noted that the term “template” as used herein may be similar or identical in meaning to the term “stent” as used in some of the patent applications cited above in the “Related Applications” section. In some embodiments of the invention, seating on a plurality of oral structures, instead of just one, provides the template with added stability during the implantation. In an embodiment of the invention, an implantation space is a portion of the template that has been left without structure to allow for access to an underlying patient's anatomy in order to perform implantation. An exposed implantation space means that the part of the template which has been left without structure is not enclosed on at least one side. Exposed implantation spaces provide an attending medical professional with enhanced visibility while performing implantation, in an embodiment of the invention. In some embodiments of the invention, exposed implantation spaces provide flexibility, optionally in conjunction with at least one drill guide described herein, to the attending medical professional to modify an implantation plan at the time of performing the implantation. In some embodiments of the invention, gaps are provided to the template where the template seats on the oral structures so that the attending medical professional can confirm visually that the template is seated properly. In some embodiments of the invention, the template seats on consecutive oral structures. Optionally, the template seats on non-contiguous oral structures.

In some embodiments of the invention, the template is provided with a connecting structure extending between two different portions of the template. The connecting structure is optionally provided to the template for providing additional stability to the template during the implantation procedure. In some embodiments of the invention, the connecting structure is used to provide a location for mounting at least one drill guide to be used in performing the implantation procedure. Optionally, at least one fiducial marker is placed in the connecting structure for assisting with registration of the template to the patient's anatomy.

In some embodiments of the invention, the at least one drill guide is mounted to the dental template on the “bottom” of the template (i.e. on the side away from where the drill is applied through the drill guide) at least to provide increased visibility to the attending medical professional during the implantation procedure. Optionally, the at least one drill guide is attached to the “top” of the template, for example for performing drilling in the other direction such as during a sinus incision. At least one drill guide is mounted to the side of where the implantation procedure is to take place, in an embodiment of the invention. In some embodiments of the invention, a plurality of drill guide mounting points, for example slots, are provided to the template to allow the attending medical professional to choose the most appropriate mounting slot to use during the implantation procedure. (It should be understood that, when “mounting slots” are referred to herein, mounting points with an attachment mechanism other than a slot, as known in the art, may be used instead.) In some embodiments of the invention, a plurality of drill guides is provided, for example as a set, which are mounted into at least some of the plurality of drill guide mounting slots allowing the attending medical professional to mount a plurality of drill guides simultaneously and/or in order to see them and/or drill through them together.

In an embodiment of the invention, the at least one drill guide is removably attached to a mounting slot so that the attending medical professional may choose to use: a) a different interchangeable drill guide in the same mounting slot, and/or b) the same drill guide in a different mounting slot on the template. In an embodiment of the invention, drill guides are provided with a mounting section which functions as a counterpart to the mounting slots of the template, for example the mounting section is provided with a fin (male) which fits into a crevice (female) provided to the mounting slot. In some embodiments of the invention, at least one drill guide is provided with a code which is matched to a corresponding code on the template in order to ensure correct placement of the drill guide on the template. Optionally, the code is by color. Optionally, the code is by number. Optionally, the code is by shape. In some embodiments of the invention, codes are also used to identify alternative sets of drill guides, wherein the drill guides of each set are intended to be used together.

As described above, at least one fiducial marker is provided to the template for registering the template to the patient's anatomy, in an embodiment of the invention. In some embodiments of the invention, at least one fiducial marker is located in the connecting structure of the template. Fiducial marker locations are optimized, in some embodiments of the invention. Optimization of fiducial marker locations includes, as examples, placing markers nearer to an implantation site for more accurate registration at the site, spreading markers out over the template and/or allowing a medical professional to mark at least one of the markers while a software programmed controller finds the non-marked markers. In an embodiment of the invention, allowing a medical professional to mark at least one marker provides a human check to the controller's identification of marker locations. In some embodiments of the invention, some or all of the marker locations are determined automatically by the controller.

In some embodiments of the invention, the template is provided with a prosthetic mounting structure to mount prosthetic teeth as a “wax-up” to show, measure, and/or tryout what the patient's anatomy will look like after the implantation procedure is complete. Optionally, the prosthetic mounting structure is porous. In some embodiments of the invention, the wax-up is mounted to the patient during medical imaging, for example during a CT scan.

In some embodiments of the invention, the template is rapidly prototyped using devices known to those skilled in the art.

An aspect of some embodiments of the invention relates to providing at least one drill guide which changes a material characteristic over a majority of its length for performing dental implantation. In an embodiment of the invention, at least 50 percent of the drill guide changes. Optionally, at least 60 percent of the drill guide changes a material property. Optionally, at least 70 percent of the drill guide changes a material property. In an embodiment of the invention, the drill guide is initially flexible for manipulation and changes to be substantially rigid for the implantation. In some embodiments of the invention, the drill guide is replaceable and/or interchangeable with other drill guides. In an embodiment of the invention, each drill guide is provided with a guide section (for guiding a drill bit), an arm or sheath section (for properly positioning and orienting the guide section) and a mounting section (for mounting the drill guide to a dental template). In an embodiment of the invention, the arm or sheath section is adapted to be initially flexible during an initial stage of manufacturing but which is cured to be substantially rigid for use in the implantation procedure. The terms “arm” and “sheath” will be both be used herein, to refer to this section of the drill guide. Even when “sheath” is used to describe this section of the drill guide, it may comprise another kind of arm. When flexible, the sheath is adapted to be capable of manipulation in at least five degrees of freedom. Optionally, the sheath is manipulated by a dental guide manipulator during the initial stage of manufacturing. In an embodiment of the invention, the sheath is manipulated into a configuration which is in accordance with an implantation plan. Optionally, the implantation plan is plotted by a software programmed controller.

In an embodiment of the invention, the drill guide is at least partially comprised of a resin which is curable by light. Optionally, blue light, as found in most dentists' offices, is used to cure the sheath. Optionally, ultraviolet light is used to cure the sheath. In some embodiments of the invention, the sheath is comprised of composite material reinforced with transparent (optionally glass) fibers. The fibers are optionally braided, knit and/or woven for increased flexibility over non-braided, non-knit and/or non-woven fibers. Optionally, the drill guide sheath is provided with an internal spring to prevent kinking during manipulation, in accordance with an embodiment of the invention. Additionally or alternatively, an internal mesh is used to prevent kinking.

In an embodiment of the invention, the mounting section is adapted to removably mount the drill guide to the template. In an embodiment of the invention, the mounting section functions as a counterpart to mounting slots of the template, for example the mounting section is provided with a fin (male) which fits into a crevice (female) provided to the mounting slot.

In an embodiment of the invention, the guide section is adapted to have removable and/or interchangeable sleeves which are adapted to accommodate different diameter drill bits. This is useful, for example, when the medical professional starts with a small diameter drill bit to make an initial hole and then switches to a larger diameter drill bit to make a properly sized hole for the implant.

In some embodiments of the invention, at least one drill guide is provided with a code which is matched to a corresponding code on the template in order to ensure correct placement of the drill guide on the template. Optionally, the code is by color. Optionally, the code is by number. Optionally, the code is by shape. In some embodiments of the invention, codes are also used to identify alternative sets of drill guides, wherein the drill guides of each set are intended to be used together. Optionally, drill guides which are used are a combination of different drill guides from different sets.

In an embodiment of the invention, drill guides are manufactured (adjusted for use and/or cured) by the medical professional who will perform the implantation procedure and/or are manufactured at the site where the implantation procedure will be performed and, in some embodiments of the invention, at the time the procedure will be performed.

An aspect of some embodiments of the invention relates to providing a drill guide manipulator which is adapted to manipulate a drill guide in at least two degrees of freedom using an eccentric gear configuration. Optionally, a two layer eccentric gear mechanism is used. In some embodiments of the invention, the drill guide manipulator provides manipulation in at least five degrees of freedom. The eccentric gear drill guide manipulator implementation is without rails thereby reducing geometric locking malfunctions. In an embodiment of the invention, the drill guide manipulator is provided with x-y table movement to effectuate at least some of the at least five degrees of freedom. In an embodiment of the invention, z-axis movement is provided to the drill guide manipulator by moving a holding rod in the z-axis.

While capable of use with virtually any manipulation apparatus, in an embodiment of the invention, the drill guide manipulator is provided with a plurality of seats which are adapted to mate with a drill guide mounting section and/or which function to reduce the dynamic range of the drill guide manipulator required to manipulate the drill guide into a proper position and/or orientation in the at least two degrees of freedom. Optionally, each of the plurality of seats is provided with a corresponding indicator, for example an LED, to indicate to a user which seat to use in order to manipulate the drill guide.

In some embodiments of the invention, the drill guide manipulator is provided with a removable top portion which can be separately sterilized in between uses.

In an embodiment of the invention, the drill guide manipulator is adapted for use by a medical professional who will perform the implantation procedure and/or is adapted to be used at a site where the implantation procedure will be performed. In an embodiment of the invention, the drill guide manipulator manipulates the drill guide in accordance with an implantation plan created at least in part by a software programmed controller.

An aspect of some embodiments of the invention relates to providing a system for providing dental implants including a drill guide manipulator capable of manipulating in at least two degrees of freedom using an eccentric gearing mechanism and/or at least one initially flexible drill guide. In an embodiment of the invention, the system also is comprised of at least one of: a dental template or a software programmed controller. Optionally, a medical imaging system, such as a CT or x-ray scanning device is used in conjunction with the system.

In an embodiment of the invention, the dental template is made to match a patient's anatomy. Optionally, the patient's anatomy is determined using a standard dental impression. A medical professional optionally uses a controller to plan an implantation procedure using at least the dental template and/or scanned images of the patient's anatomy (possibly also including the template). The drill guide manipulator is then used to manipulate the at least one initially flexible drill guide in at least two degrees of freedom to ensure correct dental implant implantation in accordance with the implantation plan, in an embodiment of the invention. In some embodiments of the invention, the drill guide manipulator is automatically controlled by the software programmed controller to manipulate the at least one drill guide. In some embodiments of the invention, the properly configured drill guide is subsequently mounted on the dental template in order to guide the attending medical professional with the implantation procedure.

In some embodiments of the invention, the template is rapidly prototyped using devices known to those skilled in the art, for example Objet, SLA, SLS, or lamination. In an embodiment of the invention, a dental template is provided to the system which seats on a plurality of oral structures and which is provided with at least one exposed implantation space. In an embodiment of the invention, at least one initially flexible and/or replaceable and/or interchangeable drill guide for performing dental implantation is provided to the system.

In some embodiments of the invention, it is envisioned that the drill guides are adjusted and/or cured by the medical professional performing the implantation procedure at the site of the procedure. It is also envisioned, in some embodiments of the invention, that should the medical professional make any changes in the planned procedure, that at least one new drill guide suitable for the changed plan can be made quickly and/or cheaply and/or at the site of the procedure.

In some embodiments of the invention, a plurality of drill guides is provided to the system. Optionally, alternative sets of drill guides are provided for use by the medical professional. Optionally, a combination of drill guides are selected for use by the medical professional from more than one set of drill guides. In some embodiments of the invention, at least one drill guide is provided with a code which is matched to a corresponding code on the template in order to ensure correct placement of the drill guide on the template. Optionally, the code is by color. Optionally, the code is by number. Optionally, the code is by shape. In some embodiments of the invention, codes are also used to identify alternative sets of drill guides, wherein the drill guides of each set are intended to be used together. Optionally, drill guides which are used are a combination of different drill guides from different sets.

In an embodiment of the invention, the drill guide manipulator is provided with eccentric gearing to provide at least some of the at least five degrees of freedom. In an embodiment of the invention, the drill guide manipulator is provided with a plurality of seats which are adapted to mate with a drill guide mounting section and/or which function to reduce the required dynamic range of the drill guide manipulator to manipulate the drill guide in at least five degrees of freedom. Optionally, each of the plurality of seats is provided with a corresponding indicator, for example an LED, to indicate to a user which seat to use in order to manipulate the drill guide.

An aspect of some embodiments of the invention relates to supporting a medical professional's ability to make an implantation plan and/or to execute an implantation plan, optionally independently of one another. For example, once an implantation plan is calculated and at least one drill guide is made according to that plan, the medical professional is afforded the flexibility to change the plan (and thus drill guides) on the spot, optionally during the execution of the implantation procedure. In an embodiment of the invention, a modular characteristic of the drill guides allows them to be interchanged and/or replaced upon the change of the implantation plan without needing to change a dental template. In some embodiments of the invention, previously made drill guides are stored by a software programmed controller enabling the medical professional to request new drill guides which are slightly modified versions of previously made drill guides.

In an embodiment of the invention, a dental impression is made of a patient's anatomy. The impression is optionally scanned, for example using CT imaging, in an embodiment of the invention. A dental template which seats on a plurality of oral structures and which is provided with at least one exposed implantation space is custom made according to the impression and/or in accordance with a medical professional's rudimentary plan for implantation, in an embodiment of the invention. Optionally, the template is rapidly prototyped. Optionally, the template is provided with a plurality of mounting slots for mounting at least one drill guide thereto. In an embodiment of the invention, an image is acquired of the patient's anatomy with or without the template in place.

Registration of the template to the patient's anatomy is performed using at least the image acquired of the patient's anatomy and information regarding the template, for example fiducial markers. Additionally, alternatively and/or optionally, a surface matching method is used which matches surface features of the patient's anatomy with surface features of the template for registration. In some embodiments of the invention, registration is at least partially performed using a plurality of impressions of the patient's anatomy, for example lower jaw, upper jaw and bite, which are registered together and then registered to the template to create a three dimensional model of the patient's anatomy. Optionally, a software programmed controller is used to perform registration of the plurality of impressions, the template and/or images of the patient's anatomy.

Using a model which includes a template which is registered to the patient's anatomy, an implantation plan is plotted which includes at least the proper orientation and/or position of at least one drill guide, which is at least initially flexible, for assisting the attending medical professional with carrying out the implantation procedure, in an embodiment of the invention. Optionally, the implantation plan is at least partially created by a software programmed controller.

In an embodiment of the invention, the at least one drill guide is created using a drill guide manipulator, which is adapted to manipulate the at least one drill guide in at least two degrees of freedom using an eccentric gearing configuration. Optionally, the drill guide manipulator is controlled by a software programmed controller for manipulating the at least one drill guide into a position and/or orientation in accordance with the implantation plan. In an embodiment of the invention, a plurality of interchangeable drill guides is created with alternative guidance to an implantation site. Optionally, a plurality of alternative sets of drill guides is created to enable the attending medical professional the flexibility to choose which set to use during implantation and/or according to the patient's needs. In some embodiments of the invention, creation of drill guides is performed chair-side and/or is computer-adjusted and/or is manufactured according to the needs as they arise, even during the implantation procedure. In some embodiments of the invention, a combination of a plurality of drill guides is chosen from more then one alternative set of drill guides.

In some embodiments of the invention, the at least one drill guide is placed in one of a plurality of mounting slots provided to the dental template which provides the most advantageous condition for performing implantation according to the implantation plan. Implantation is performed using the at least one drill guide mounted on the dental template, in accordance with an exemplary embodiment of the invention.

An aspect of some embodiments of the invention relates to making at least one drill guide using a drill guide manipulator adapted for manipulating the at least one drill guide in at least two degrees of freedom using an eccentric gearing configuration. In an embodiment of the invention, an implantation plan is created which plots intended sites of implantation and/or proper orientation and/or position of at least one drill guide assisting an attending medical professional with the implantation procedure. Optionally, the implantation plan is created using an image of the patient's anatomy and a software programmed controller. Optionally, the image is a CT image. In some embodiments of the invention, a plurality of drill guides is planned for in the implantation plan. Optionally, alternative sets of drill guides are planned for wherein each set is at least slightly varied in position and/or orientation with respect to the implantation sites. In an embodiment of the invention, an at least initially flexible drill guide is placed in a drill guide manipulator.

In an embodiment of the invention, the software programmed controller is adapted to issue commands to the drill guide manipulator wherein the commands cause the manipulator to manipulate at least one drill guide into a position and/or orientation according to the implantation plan. In an embodiment of the invention, a plurality of mounting seats, into which a mounting section of a drill guide seats, are provided to the drill manipulator for reducing the dynamic range of the manipulator required for manipulation of the drill in the at least two degrees of freedom. In some embodiments of the invention, an LED is provided to each of the plurality of seats to indicate which mounting seat should be used, wherein the mounting seat which should be used is indicated by a lit LED. Optionally, the controller determines which LED should be lit.

When each drill guide has been manipulated into a correct position and/or orientation according to the implantation plan, the drill guide is cured to make it rigid, in an embodiment of the invention. In an embodiment of the invention, the drill guide is at least partly comprised of a resin which is light curable. Optionally, the drill guide is cured using blue light, for example the kind found in a dentist's office. Optionally, the drill guide is cured using ultraviolet light.

In some embodiments of the invention, at least a portion of the manipulator, for example a top portion, is adapted to be removed for sterilization between uses.

In some embodiments of the invention, at least one guide is used to guide the attachment of the template to the jaw, for example by drilling a hole for a pin or screw to be inserted into the jaw, the pin or screw going through the drill guide or not, or by inserting a screw into the jaw using the guide, even without drilling a hole first. In these cases, the drill guide is, for example, positioned over a small hole in the template, designed for attaching the template to the jaw, and not over a large opening, as when the drill guide is used directly to guide an implantation. Attaching the template to the jaw first may be especially useful for extended procedures, such as oral surgery. In some of these embodiments of the invention, a guide is used not to guide drilling, or not only to guide drilling, but to guide cutting during oral surgery.

There is thus provided in accordance with an embodiment of the invention, a template for performing a dental implantation procedure, comprising: a main body adapted to seat on a plurality of oral structures, and at least one mounting point on the main body for mounting at least one drill guide, wherein the main body is provided with at least one exposed implantation space where the dental implantation is to be performed. In an embodiment of the invention, the at least one mounting point comprises a mounting slot.

There is further provided, in accordance with an embodiment of the invention, a system for performing a dental implantation procedure, comprising a dental template according to an embodiment of the invention, and a drill guide, adapted to mount to the mounting point such that the drill guide will be at a fixed position and orientation relative to the template, wherein the drill guide is capable of being adjusted to determine said position, orientation, or both.

Optionally, the template is provided with a plurality of mounting points on the main body for mounting at least one drill guide. Optionally, the oral structures are at least one of a tooth, soft tissue or a healing cap. In an embodiment of the invention, the template further comprises a connecting structure on which at least one mounting slot for at least one drill guide is located. Optionally, the connecting structure is provided with at least one fiducial marker location. Optionally, the at least one drill guide mounts on the bottom of the template. Optionally, at least the main body is rapidly prototyped. In an embodiment of the invention, the template further comprises at least one fiducial marker detectable in a medical imaging scan. Optionally, the at least one fiducial marker is comprised of aluminum oxide. In an embodiment of the invention, the template further comprises a prosthetic mounting structure adapted to removably attach to the main body for showing a potential result of the dental implantation procedure. Optionally, a prosthetic is a tooth. In an embodiment of the invention, the template further comprises at least one code type to indicate in which mounting slot the at least one drill guide should be placed. Optionally, a code type is color. Optionally, a code type is a number. Optionally, a code type is shape. Optionally, the at least one drill guide is mounted to the side of the at least one exposed implantation space. Optionally, the at least one drill guide is adapted for performing a sinus incision. Optionally, the at least one drill guide is adapted for performing the attachment of the template to the jaw. There is further provided in accordance with an embodiment of the invention, a drill guide for performing a dental implantation procedure, comprising: a mounting section adapted for removably mounting the drill guide to at least one of a dental template or dental guide manipulator; a guide section adapted for passage therethrough of a drill bit; and, a selectively flexible or rigid arm configurable with at least one of a proper position or orientation by the dental guide manipulator for performing the dental implantation procedure. Optionally, the selectively flexible arm is comprised of woven, braided or knit fibers. Optionally, the selectively flexible arm is comprised of a light curable resin. Optionally, the light curable resin is curable by at least one of blue light or ultraviolet light. Optionally, the drill guide is selected to be flexible prior to the dental implantation procedure and is selected to be rigid during the implantation procedure. Optionally, the drill guide is one of a plurality of differently configured drill guides forming a set of drill guides. Optionally, the guide section accommodates each of a plurality of different sleeves for guiding drills of different diameter and/or shape. Optionally, at least one of the sleeves fits inside another one of the sleeves. Optionally, a first one of the sleeves is removable only from a first side of the drill guide, and a second one of the sleeves, which fits inside the first one of the sleeves, is removable only from a second side of the drill guide, opposite to the first side.

In an embodiment of the invention the drill further comprises a code type tag used for mounting the drill guide to the dental template in a correct position.

There is further provided in accordance with an embodiment of the invention, a drill guide manipulator for manipulating drill guides to be used in a dental implantation procedure, comprising: at least one mounting seat provided to a top portion of the drill guide manipulator and adapted to mate with a mounting section of a drill guide; a manipulator rod adapted to mate with a guide section of the drill guide; an eccentric gear configuration for providing the movement to the mounting rod; and wherein movement of the manipulator rod with respect to the at least one mounting seat provides movement to the drill guide in at least two degrees of freedom. In an embodiment of the invention, the drill guide manipulator further comprises at least one indicator associated with the at least one mounting seat for indicating the drill guide should be mated to the mounting seat. Optionally, the top portion is removable from the drill guide manipulator for at least one of cleaning, sterilization or maintenance. Optionally, the manipulator is provided with operative communication to a controller.

There is further provided in accordance with an embodiment of the invention, a system for performing a dental implantation procedure, comprising: a dental template; a software programmed controller adapted to register the dental template to a patient's anatomy and calculate a dental implantation plan which includes at least one drill guide configuration in accordance with the plan; at least one selectively flexible drill guide manipulated into the configuration in accordance with the plan and removably attached to the dental template; and, a drill guide manipulator adapted to manipulate the at least one drill guide into the configuration in accordance with the plan using an eccentric gear configuration. Optionally, the dental template is provided with at least one exposed implantation space proximal to where the dental implantation procedure is to take place. Optionally, the drill guide manipulator is adapted to manipulate the at least one drill guide in at least 2 degrees of freedom. Optionally, the drill guide manipulator manipulates in response to commands received from the controller.

There is further provided in accordance with an embodiment of the invention, a method of performing a dental implantation procedure, comprising: making a customized dental template of a patient's anatomy; registering the template with the patient's anatomy, using an image of the patient's anatomy; calculating an implantation plan including at least one proper drill guide configuration relative to the template, in accordance with the implantation plan; creating at least one drill guide so that it will be in the proper drill guide configuration when it is attached to the template, in accordance with the implantation plan using a drill guide manipulator adapted to manipulate the at least drill guide in at least two degrees of freedom; attaching the drill guide to the template such that the drill guide will be in the proper drill guide configuration relative to the template, and relative to the patient's anatomy when the template is registered; and implanting at least one dental implant using the at least one drill guide, when the drill guide is attached and the template is registered.

Optionally, the customized dental template is made according to a dental impression of the patient's anatomy. Optionally, the customized dental template is made according to a scanned image of the patient's anatomy. Optionally, calculating is performed by a software programmed controller. Optionally, the controller commands the drill guide manipulator to manipulate according to the implantation plan. Optionally, registering is performed by matching surfaces of the dental template and the patient's anatomy. Optionally, registering is performed using fiducial markers located in the dental template. Optionally, creating commences with an initially flexible drill guide and ends with a substantially rigid drill guide. Optionally, the drill guide is cured using at least one of blue light or ultraviolet light.

Optionally, making a customized dental template comprises making a template of the upper jaw, a template of the lower jaw, and a bite template, registering the template to the patient's anatomy comprises registering the upper jaw template relative to the lower jaw template using the bite template, thereby obtaining occlusion information, and calculating an implantation plan comprises using the occlusion information. Optionally, calculating an implantation plan comprises using an image of the template overlayed on an image of the patient's anatomy.

There is further provided in accordance with an embodiment of the invention, a method of making at least one drill guide using a drill guide manipulator, comprising: planning implant locations using a previously acquired image of a patient's anatomy and a software programmed controller; plotting at least one of position or orientation of the at least one drill guide based on the planned implant locations; using an eccentric gear configured drill guide manipulator to create the at least one drill guide according to at least one of plotted position or orientation received from the controller; and, curing the at least one drill guide to make it substantially rigid. Optionally, curing is performed by at least one of blue light or ultraviolet light. Optionally, using the drill guide manipulator includes choosing a mounting seat from a plurality of mounting seats for creating the at least one drill guide. Optionally, the mounting seat to be chosen is indicated by an indicator.

### BRIEF DESCRIPTION OF THE FIGURES

Non-limiting embodiments of the invention will be described with reference to the following description of exemplary embodiments, in conjunction with the figures. The figures are generally not shown to scale and any measurements are only meant to be exemplary and not necessarily limiting. In the figures, identical structures, elements or parts which appear in more than one figure are preferably labeled with a same or similar number in all the figures in which they appear, in which:

FIG. 1 is a schematic diagram of an exemplary system for making and using dental templates and related devices, in accordance with an exemplary embodiment of the invention;

FIG. 2A is a perspective view of a dental template, in accordance with an exemplary embodiment of the invention;

FIG. 2B is a perspective view of a dental template with a prosthetic mounting structure, in accordance with an exemplary embodiment of the invention;

FIG. 3A is a perspective view showing a drill guide in a pre-manipulated configuration, in accordance with an exemplary embodiment of the invention;

FIG. 3B is an exploded view of a drill guide in a pre-manipulated configuration, in accordance with an exemplary embodiment of the invention;

FIG. 3C is a perspective view showing a drill guide in a post-manipulated configuration, in accordance with an exemplary embodiment of the invention;

FIG. 4A is a perspective view of a top portion of a drill guide manipulator, in accordance with an exemplary embodiment of the invention;

FIG. 4B is a perspective view of a drill guide manipulator with an eccentric configuration, in accordance with an exemplary embodiment of the invention;

FIG. 4C is a perspective view of gearing for a drill guide manipulator with an eccentric configuration, in accordance with an exemplary embodiment of the invention;

FIG. 5 is a perspective view of a dental template with drill guides, in accordance with an exemplary embodiment of the invention

FIG. 6 is a flowchart of a flexible method for providing at least one dental implant, in accordance with an exemplary embodiment of the invention; and,

FIG. 7 is a flowchart of a method for making at least one drill guide, suitable for use in an implantation plan, using a drill guide manipulator, in accordance with an exemplary embodiment of the invention.

### DETAILED DESCRIPTION OF EXEMPLARY EMBODIMENTS

### Exemplary General System

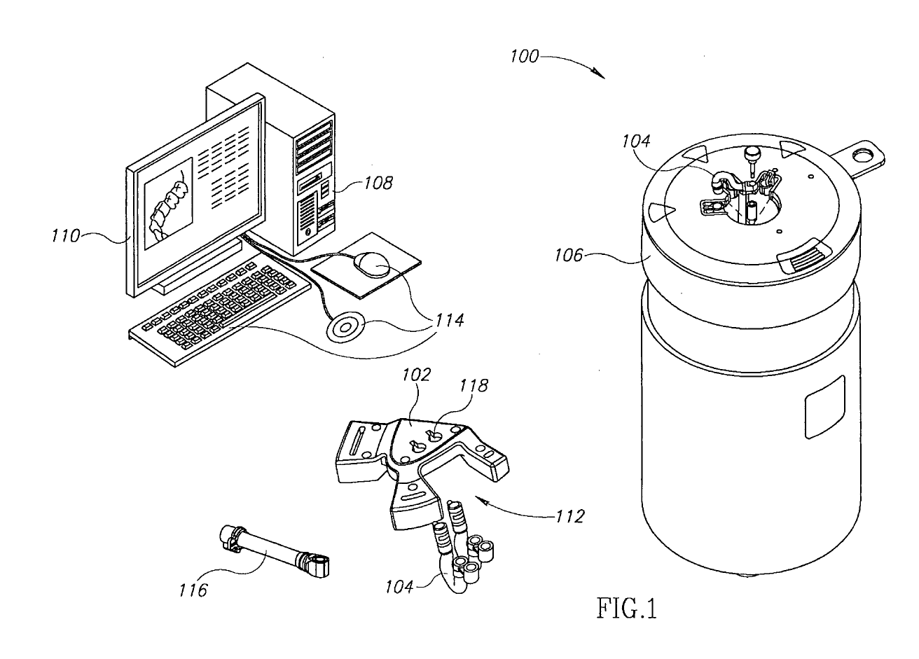

Referring to FIG. 1, a schematic diagram of an exemplary system 100 for making and/or utilizing dental templates and/or related devices is shown, in accordance with an exemplary embodiment of the invention. In an embodiment of the invention, system 100 is used to make devices and/or formulate plans which assist a medical professional with carrying out a dental procedure, for example dental implantation for the placement of prosthetic teeth in a patient's mouth. In an exemplary embodiment of the invention, system 100 is provided with components including at least one dental template 102, at least one drill guide 104, a drill guide manipulator 106 and/or a software programmed controller 108. Optionally, at least one medical imaging device, a rapid prototyping device and/or a dental impression device is provided to system 100.

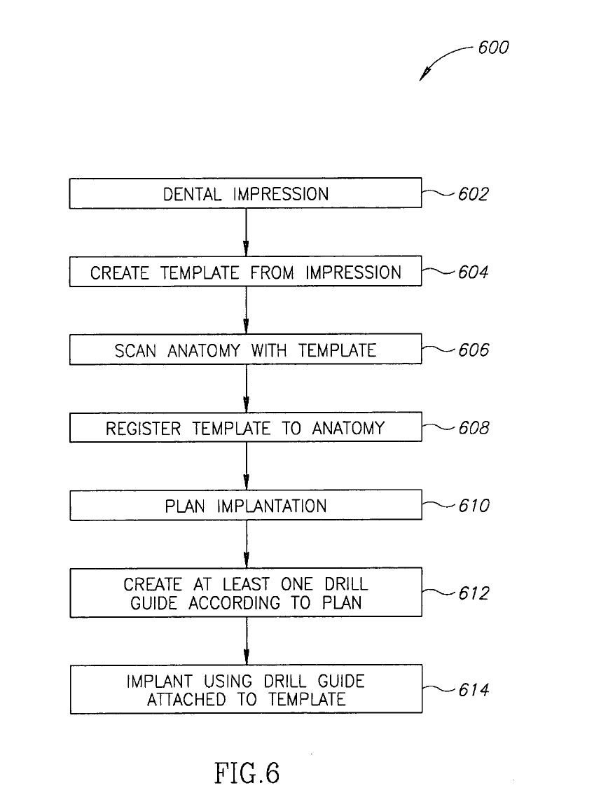

As described below in more detail with respect to the method of FIG. 6, system 100 is used, in some embodiments of the invention, to create a plan for a dental implantation and then create devices in accordance with that plan. In some embodiments of the invention, the plan and the devices created to carry out the plan are at least partly flexible, in that the medical professional is provided with options to adjust the plan and devices depending on the perceived needs of the patient.

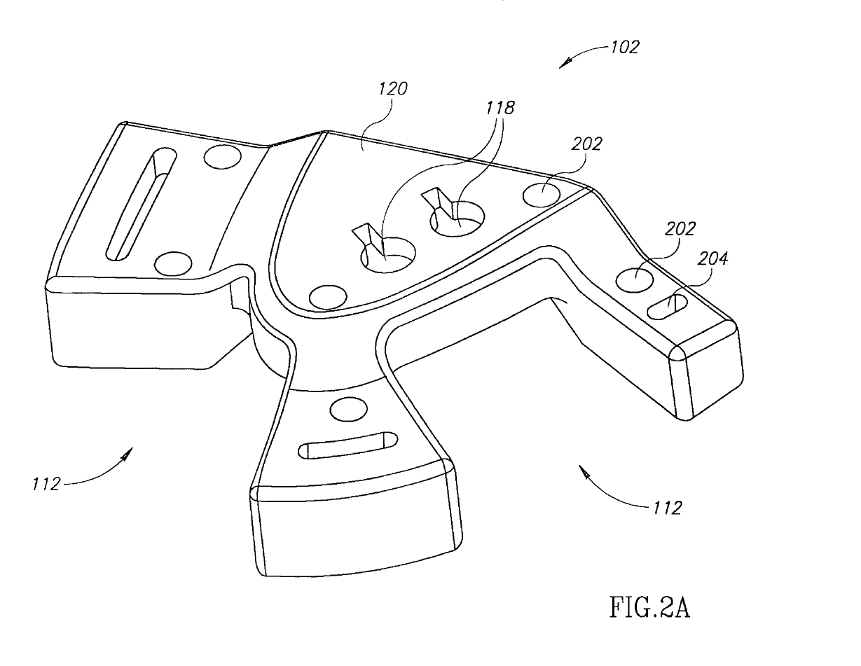

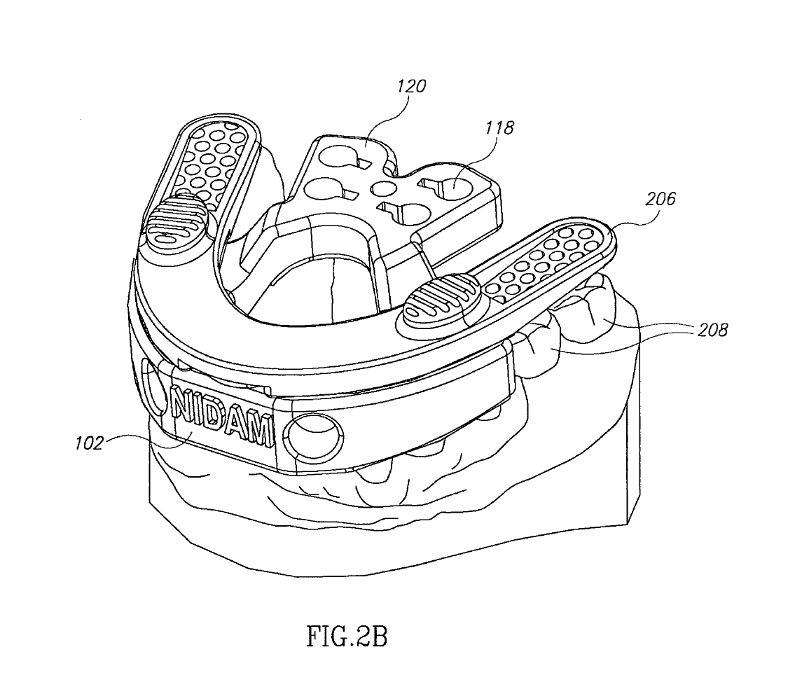

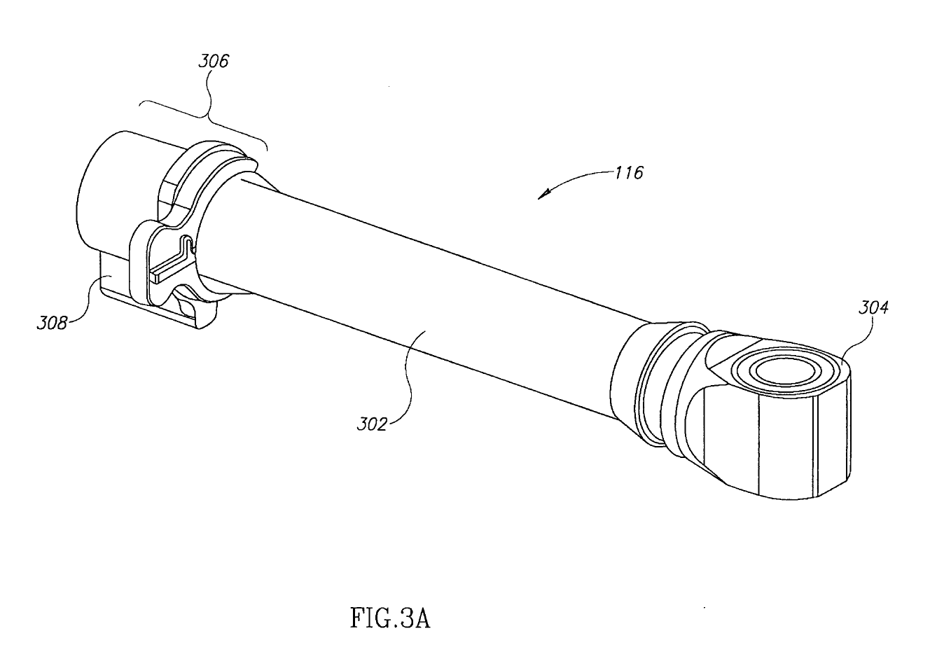

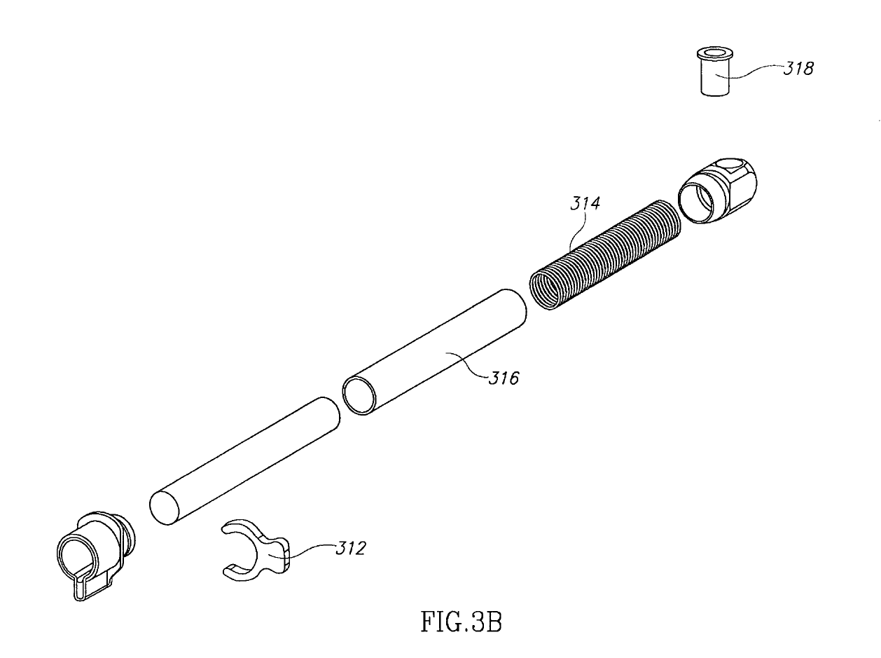

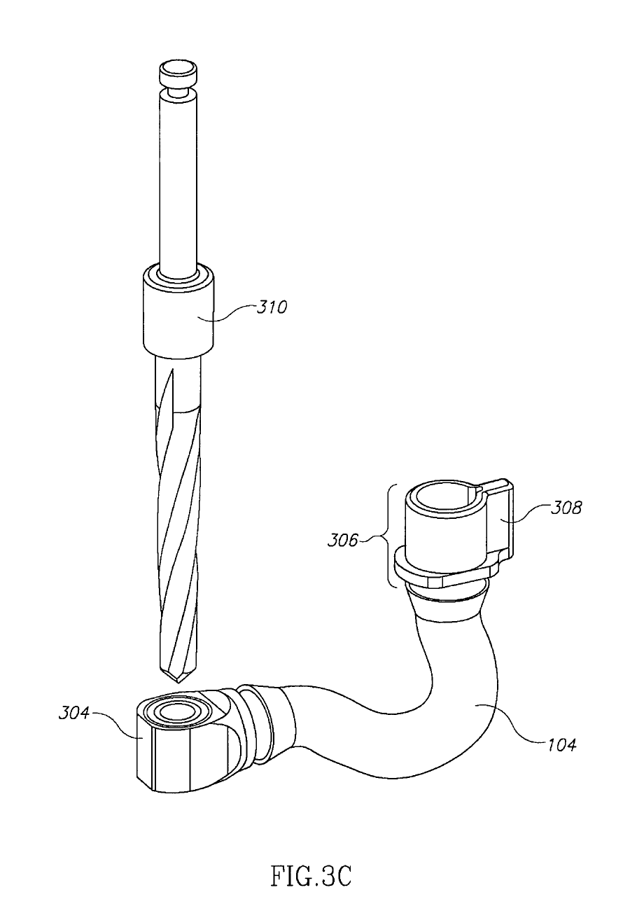

In an embodiment of the invention, dental template 102 (exemplary templates described in more detail below with respect to FIGS. 2A-B) has been custom made to fit the patient's anatomy and to account for where the medical professional will be performing the dental implantation by incorporating at least one exposed implantation space 112. Using an output device 110 connected to controller 108, a medical professional can examine information related to the patient and decide, based at least partly on that information, how to perform the dental implantation on the patient. Information regarding the patient can include imaging of the patient's anatomy, a dental template 102 registered to the anatomy, any digital renderings of the patient's anatomy, the patient's medical history and/or the patient's current medical needs. In an embodiment of the invention, the medical professional indicates to controller 108, optionally using an input device 114, where in relation to the patient's anatomy, and thus dental template 102, the dental implantation will occur. Based on this indication, controller 108 can calculate the proper orientation and/or position needed for a drill guide 104 (exemplary drill guides described in more detail below with respect to FIGS. 3A-C) mounted on dental template 102 in order to properly align the medical professional's dental drill with the implantation site and according to the implantation plan.

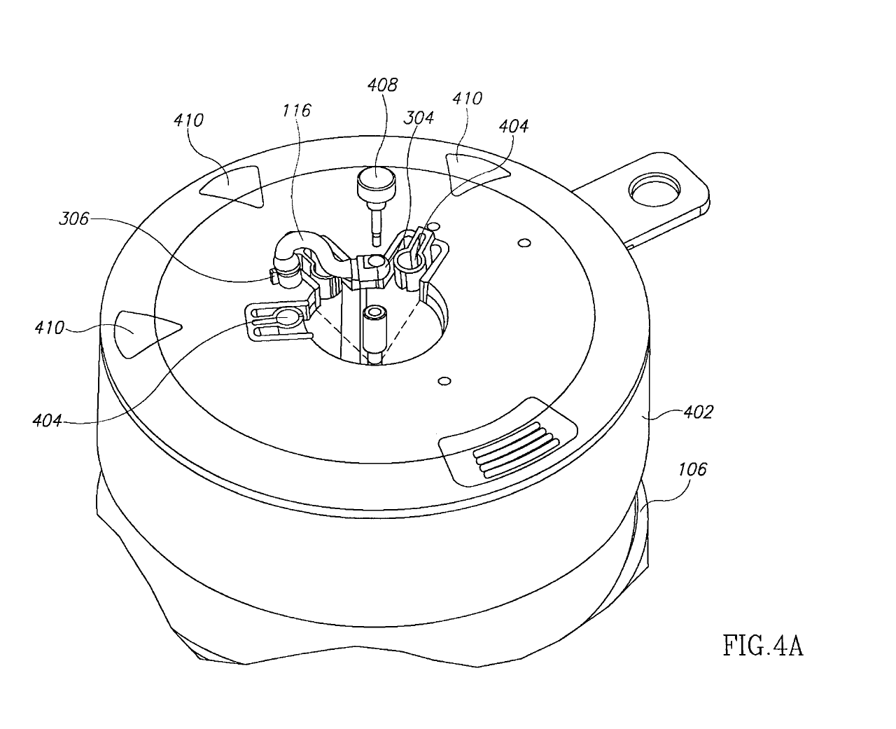

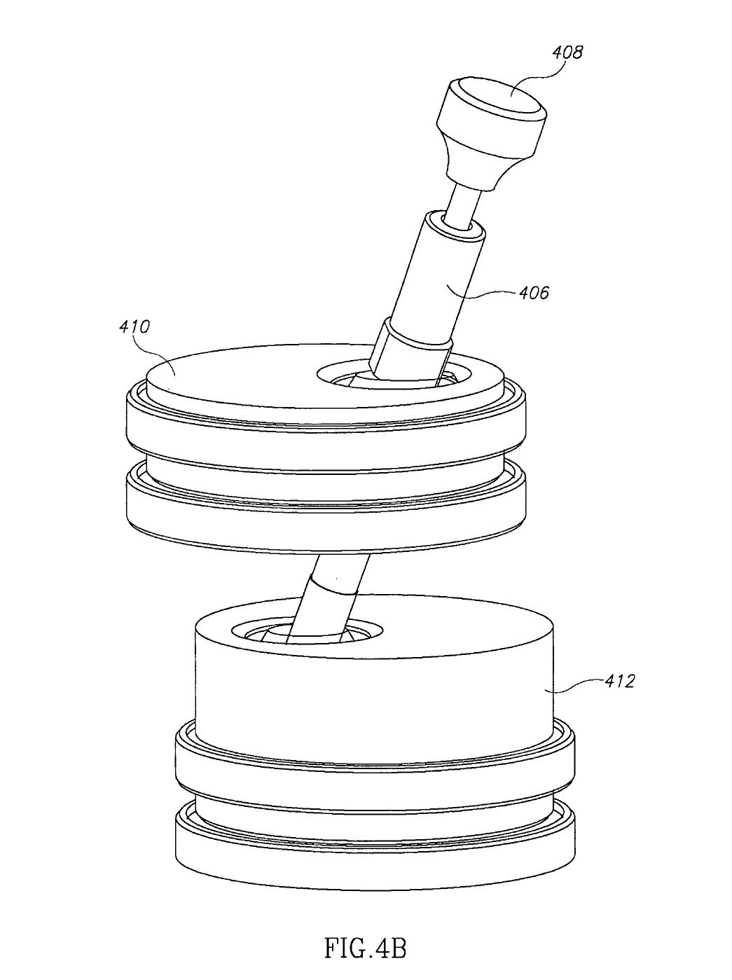

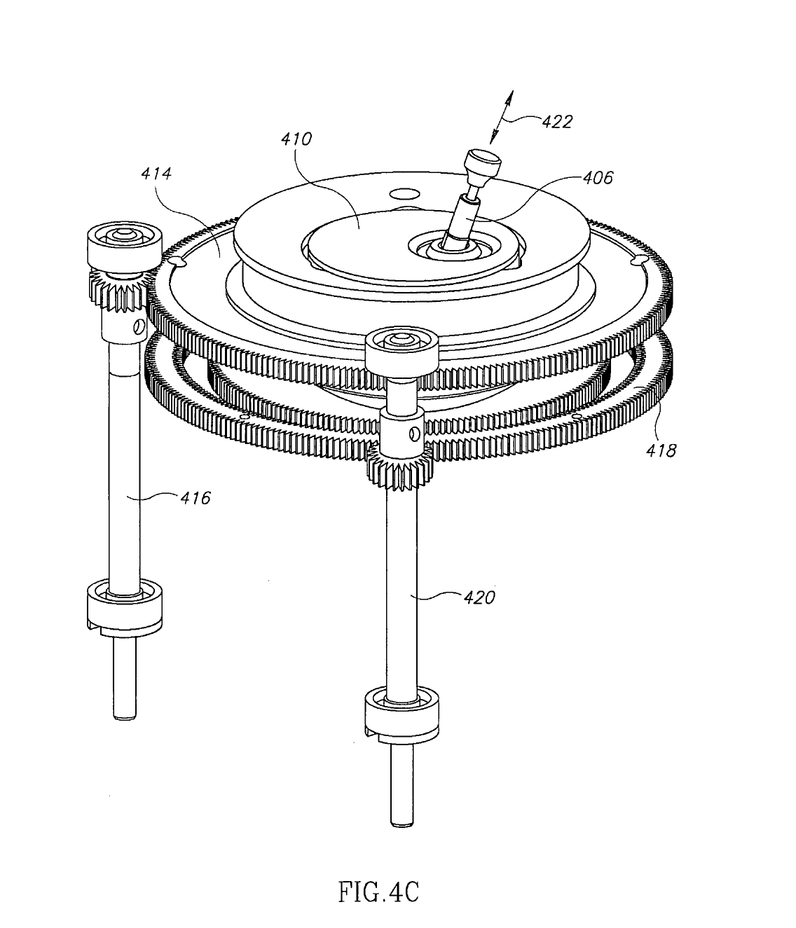

In some embodiments of the invention, an initially flexible, pre-configured drill guide 116 is placed into drill guide manipulator 106 (exemplary manipulators described in more detail below with respect to FIGS. 4A-C) to be formed with the proper orientation and/or position as calculated by controller 108 according to the implantation plan. Drill guide manipulator 106 is adapted to manipulate drill guide 116 in at least two degrees of freedom using an eccentric gearing configuration, in some embodiments of the invention. Pre-configured drill guide 116, once formed into a proper configuration in accordance with the implantation plan, is cured to make a rigid drill guide 104 suitable for use during the implantation procedure. At least one drill guide 104 which has been configured for use in a dental implantation procedure is placed within one of optionally a plurality of mounting slots 118 located on template 102.

In some embodiments of the invention, system 100 is adapted to be used by a medical professional at the medical professional's office or clinic. For example, drill guide manipulator 106 is constructed of relatively inexpensive parts and/or is relatively inexpensive to manufacture so that it is affordable for a broad range of medical professionals. In some embodiments of the invention, components of system 100 are portable and/or are sized to be used in the office or clinic.

### Exemplary Dental Template

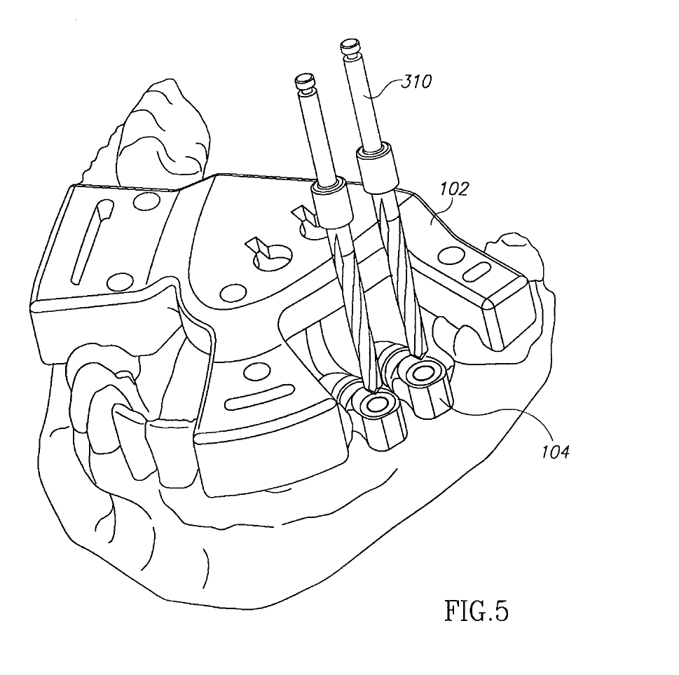

FIG. 2A is a perspective view of dental template 102, in accordance with an exemplary embodiment of the invention. Template 102 is customized to a particular patient's anatomy, in some embodiments of the invention, using at least one previously acquired dental impression of the patient's anatomy. In an embodiment of the invention, template 102 is adapted to seat on a plurality of oral structures in the patient's mouth, for example a tooth, soft tissue such as the gums, or a “healing cap” with edentulous or partially edentulous patients, to provide stability to template 102 during the implantation procedure. FIG. 5 shows template 102 with a plurality of drill guides 104 seated on a plurality of teeth according to an exemplary embodiment of the invention.

Template 102 is also provided with at least one exposed implantation space 112 wherein the space 112 is not completely enclosed by template 102 and wherein the at least exposed implantation space 112 is located above or below the site where implantation is to take place. In an embodiment of the invention, at least one exposed implantation space 112 is not enclosed to provide enhanced visibility (over an enclosed space) to the medical professional for performing the implantation procedure and/or to provide flexibility to the medical professional in carrying out the procedure. Optionally, the open side of exposed implantation space 112 extends about 10 mm along the jaw, for example for a single implant, or about 16 mm, for example for two adjacent implants, or is less than 10 mm, or between 10 and 16 mm, or longer than 16 mm. Optionally, the open side of exposed implantation space 112 extends from the third or fourth tooth all the way back. Optionally, exposed implantation space 112 extends less than 5 mm across the jaw, or between 5 and 10 mm, or more than 10 mm. Examples of flexibility provided to the professional include being able to examine the patient's condition at the time of the procedure to determine if there is a reason why the implantation plan should be altered (reasons include bone regrowth after tooth extraction, initial plan was based on unclear images of patient's anatomy, soft tissue issues) and/or the ability to change drill guide configurations and/or mounting locations on template 102 while still being able to use the same template.

In an embodiment of the invention, template 102 is provided with at least one mounting slot 118 wherein drill guide 104 is removably mounted to template 102. Optionally, a plurality of mounting slots 118 is provided to template 102. In some embodiments of the invention, a plurality of mounting slots 118 is used because more than one drill guide 104 is going to be used during the implantation procedure (i.e. more than one implant is being placed in the patient). Alternatively, additionally or optionally, a plurality of mounting slots 118 is used in order to allow the medical professional to mount several drill guides simultaneously and allow the flexibility to change the implantation plan and move at least one drill guide 104 from one slot to another to allow for drilling from a different position and/or orientation. In an embodiment of the invention, mounting slot 118 is adapted to mate with a mounting section (described below with respect to FIGS. 3A-C) of drill guide 104 in a counterpart fashion, for example where mounting slot 118 is provided with a crevice (female) which is the counterpart for a fin (male) located on the mounting section of drill guide 104. In some embodiments of the invention, mounting slot 118 configuration is universally compatible with mounting sections of a plurality of drill guides enabling interchangeability and/or replaceability of the drill guides.

In some embodiments of the invention, at least one drill guide is mounted to dental template 102 on the “bottom” of the template at least to provide increased visibility to the attending medical professional during the implantation procedure. Drill guides are mounted to mounting slot 118 which is not axially aligned with the implantation site, in an embodiment of the invention. In some embodiments of the invention, the at least one drill guide is mounted to the “top” of the template. In some embodiments of the invention, a drill guide is used for guiding a sinus incision.

In an embodiment of the invention, template 102 is provided with a connecting structure 120 extending between two different portions of template 102. Connecting structure 120 is optionally provided to template 102 for providing additional stability to template 102 during the implantation procedure. In some embodiments of the invention, connecting structure 120 is used to provide a location for mounting at least one drill guide to be used in performing the implantation procedure.

At least one fiducial marker is provided to template 102 to assist with registration of template 102 to the patient's anatomy, in an exemplary embodiment of the invention. Fiducial markers are placed in marker positions 202 located on template 102 including, in some embodiments of the invention, connecting structure 120. Fiducial markers are typically comprised of a material which is detectable in the scan used to image the patient's anatomy. In an embodiment of the invention, the fiducial markers are comprised of aluminum oxide. When template 102 is placed in patient's mouth during imaging, the fiducial markers appear on the output image in relation to the anatomical features of the patient. This allows for one method of registration of template 102 and its fiducial markers to the patient's anatomy. Fiducial marker locations on template 102 are optimized, in some embodiments of the invention. Optimization of fiducial marker locations includes, as examples, placing markers nearer to an implantation site for more accurate registration at the site, spreading markers out over template 102 and/or allowing a medical professional to mark at least one of the markers while a software programmed controller finds the non-marked markers. In an embodiment of the invention, allowing a medical professional to mark at least one marker provides a human check to the controller's identification of marker locations. In some embodiments of the invention, some or all of the marker locations are determined automatically by the controller. In some embodiments of the invention, fiducial markers are placed in locations on template 102 which are expected to be streak-free in a CT image, for example on a plane a few mm above the patient's teeth.

In an embodiment of the invention, template 102 is provided with at least one gap 204 proximal to where template 102 seats on an oral structure so that the attending medical professional can confirm, for example by seeing the oral structure through the gap, that template 102 is seated properly on the oral structure.

In some embodiments of the invention, template 102 is provided with a removably attachable prosthetic mounting structure 206, shown in FIG. 2B, to mount prosthetic teeth 208 as a wax-up to show, measure, and/or tryout what the patient's anatomy will look like after the implantation procedure is complete. Optionally, prosthetic mounting structure 206 is porous for easier attachment to prosthetic teeth 208. In some embodiments of the invention, the wax-up is mounted to the patient during medical imaging, for example during a CT scan.

Optionally, prosthetic teeth are made on a stone cast and a second impression of the cast with the synthetic teeth is taken and/or registered allowing the medical professional and/or the controller to overlay the two impressions using software for a “virtual” wax-up.

Another option is to recognize these extra teeth in the software (by subtracting the two impressions) and allowing the medical professional to manipulate the teeth in the software for extra flexibility.

In an exemplary embodiment of the invention, an impression is made not only of the jaw (upper or lower) where the template will fit, but also of the other jaw and/or of the bite, and the impressions are registered relative to each other, for example in order to obtain additional information about the patient's mouth and occlusion, for example the relative position of the upper and lower jaw when biting, to use in planning the implant procedure.

It should be understood that the embodiments depicted in FIGS. 2A-B are by way of example only and that dental templates capable of use with the present invention are typically customized, and therefore, will present themselves in near infinite variety and configuration depending on factors including patient anatomy and/or patient medical needs. For example, exposed implantation spaces 112 are provided to template 102 of FIG. 2A because during planning it was determined by the medical professional that the patient needed implantation at sites corresponding to those locations on the patient's anatomy. However, it should be understood that a different patient with different needs for implantation could have a template with less or more implantation spaces and/or at least one implantation space located in a different location. In some embodiments of the invention, the template is rapidly prototyped using devices known to those skilled in the art.

### Exemplary Drill Guides

Referring to FIG. 3A, a perspective view of pre-configured drill guide 116 is shown, in accordance with an exemplary embodiment of the invention. Pre-configured drill guide 116 is provided with an at least initially flexible sheath 302, a guide section 304 and/or a mounting section 306, in an embodiment of the invention. Sheath 302 is at least initially flexible, in an embodiment of the invention, because pre-configured drill guide 116 is placed onto drill guide manipulator 106 while sheath 302 is flexible and capable of being manipulated by manipulator 106. Once sheath 302 has been manipulated into a configuration proper for use, it is cured so that it becomes rigidly locked into the configuration proper for use thus creating post-configured drill guide 104 (shown in FIGS. 1 and 3C, inter alia). In an embodiment of the invention, at least 50% of drill guide 116 changes from flexible to substantially rigid. Optionally, at least 60% of drill guide 116 changes from flexible to substantially rigid. Optionally, at least 70% of drill guide 116 changes from flexible to substantially rigid. In an embodiment of the invention, sheath 302 is at least partially comprised of a light curable resin. Optionally, blue light is used to cure sheath 302. Optionally, ultraviolet light is used to cure sheath 302. In some embodiments of the invention, sheath 302 is comprised of braided, woven and/or knit fibers rather than straight fibers in order to provide flexibility to sheath 302 that is not strictly reliant on the elasticity of the individual fibers.

Guide section 304 is used, in an embodiment of the invention, to guide a drill bit 310 (shown in FIG. 3C) used by the attending medical professional to carry out the implantation procedure. In an embodiment of the invention, drill bit 310 passes through guide section 304 during the implantation procedure. Guide section 304 is provided with a position and/or orientation at least partially by sheath 302 which enables the implantation procedure to be performed according to the implantation plan, in an exemplary embodiment of the invention. In an embodiment of the invention, guide section 304 is adapted to have removable and/or interchangeable sleeves 318, one of which is shown for example in FIG. 3B, which are adapted to accommodate drill bits of different diameter, and/or drills designed to drill holes of different cross-sectional shape, for example square holes as described in U.S. Pat. No. 4,074,778 to Morell, the disclosure of which is incorporated herein by reference. This is useful, for example, when the medical professional starts with a small diameter drill bit to make an initial hole and then switches to a larger diameter drill bit to make a properly sized and shaped hole for the implant.

In some embodiments of the invention, when sleeves 318 of different diameter are used, a smaller sleeve fits inside a larger sleeve. Optionally, three or more sleeves fit together, each of the smaller ones inside the next larger one. For example, there are three sleeves, of inner diameter 2.3 mm, 2.8 mm, and 3.4 mm, or three sleeves of inner diameter 2.8 mm, 3.4 mm, and 4.4 mm, or there are two sleeves using any two of these inner diameters, or there are four sleeves using all four of these inner diameters. Alternatively, at least one of the inner diameters is less than 2.3 mm, or between 2.3 and 2.8 mm, or between 2.8 and 3.3 mm, or between 3.4 and 4.4 mm, or greater than 4.4 mm. Optionally, the tightness of the fit between adjacent sleeves is less than 100 micrometers, or less than 50 micrometers. In some embodiments of the invention, adjacent sleeves are held in place by friction. In some embodiments of the invention, once it is decided which sleeve to use, adjacent sleeves are held in place by gluing.

When there is at least one smaller sleeve fitting inside a larger sleeve, the medical professional may initially drill a smaller hole with a smaller diameter sleeve in place, remove the inner sleeve leaving a larger diameter sleeve in place, and drill a larger hole. Optionally, alternate sleeves in order of diameter are capable of being removed from guide section 304 only from alternate sides. For example, one of the sleeves is capable of being removed only from the top, and the sleeve or sleeves adjacent to it are capable of being removed only from the bottom. Here, “top” and “bottom” refer to the orientation of guide section 304 shown in FIG. 3A or FIG. 3C. A sleeve is prevented from being removed on one side, for example, by a having a lip, a ridge, or a similar structure on the other side, such as the lip shown on the top of sleeve 318 in FIG. 3B. Such a design of the sleeves has the potential advantage that the medical professional may be less likely to unintentionally remove more than one sleeve at a time, when switching from one drill bit size to a larger drill bit size.

Mounting section 306 mates with mounting slot 118 located on template 102, in an embodiment of the invention. In some embodiments of the invention, mounting section 306 is adapted to removably mount drill guide 104 to template 102 which is desirable, for example, if the attending medical professional decides to use a different drill guide at the time of the implantation procedure. In an embodiment of the invention, mounting section 306 is adapted to mate with mounting slot 118 of drill guide 104 in a counterpart fashion, for example where mounting slot 118 is provided with a crevice (female) which is the counterpart for a fin 308 (male) located on the mounting section of drill guide 104.

In some embodiments of the invention, at least one drill guide is provided with a code which is matched to a corresponding code on the template in order to ensure correct placement of the drill guide on the template. Optionally, the code is by color. Optionally, the code is by number. Optionally, the code is by shape. In some embodiments of the invention, codes are also used to identify alternative sets of drill guides, wherein the drill guides of each set are intended to be used together. Optionally, drill guides which are used are a combination of different drill guides from different sets. In some embodiments of the invention, code type is indicated by a tag 312, shown in FIG. 3B, which is physically attached to the drill guide. Additionally, alternatively or optionally, code is indicated on template 102.

Referring to FIG. 3B, an exploded view of drill guide 116 is shown, in accordance with an exemplary embodiment of the invention. Drill guide 116 is provided with an internal spring 314 to prevent kinking during manipulation, in some embodiments of the invention. Additionally or alternatively, an internal mesh is used to prevent kinking.

FIG. 3C shows drill guide 104 cured and/or configured for use in accordance with an implantation plan, in an embodiment of the invention. It should be understood that, in some embodiments of the invention, a plurality of drill guides are made which are used additionally and/or alternatively to each other depending on the needs of the patient, the judgment of the attending medical professional and/or the implantation plan. In embodiments where there is a plurality of drill guides, they are optionally organized into sets, the sets themselves being usable additionally and/or alternatively to each other. In some embodiments of the invention, individual drill guides from more than one set are selected for use in combination. It is conceived by the inventors that drill guides are to be easily replaceable and/or interchangeable in some embodiments of the invention.

### Exemplary Drill Guide Manipulators

FIG. 4A shows a perspective view of a top portion 402 of drill guide manipulator 106, in accordance with an exemplary embodiment of the invention. As described elsewhere herein, drill guide manipulator 106 is adapted to manipulate a drill guide in at least two degrees of freedom using an eccentric gearing configuration. In an embodiment of the invention, at least initially flexible, pre-configured drill guide 116 is placed in a mounting seat 404, mounting seat 404 being located on top portion 402 and/or adapted to mate with mounting section 306 of drill guide 116. In some embodiments of the invention, a plurality of mounting seats 404 are provided to drill guide manipulator 106 wherein drill guide 116 is placed in one or more of these mounting seats 404 during the manipulating in order to reduce the dynamic range of motion that is required of drill guide manipulator 106.

Guide section 304 of drill guide 116 is removably attached to a manipulation rod 406 using, for example, a locking pin 408, in accordance with an embodiment of the invention. Locking pin 408 passes through guide section 304, in a similar fashion to drill bit 310, and removably locks to manipulation rod 406 thereby fastening drill guide 116 to manipulation rod 406.

In an embodiment of the invention, movement of manipulation rod 406 by gearing (shown in FIG. 4C) of drill guide manipulator 106 causes movement of guide section 304 with respect to seated mounting section 306. This movement causes at least initially flexible sheath section 302 to move in at least two degrees of freedom to assume a proper configuration for carrying out the implantation plan. In an embodiment of the invention, commands for moving manipulation rod 406 are received by drill guide manipulator 106 from controller 108, which is programmed with the implantation plan. In some embodiments of the invention, indicators 410, such as LEDs, are provided to top portion 402 to indicate to a user of drill guide manipulator 106 which mounting seat 404 to use. Optionally, controller 108 signals to drill guide manipulator 106 which indicator 410 to alight in order to make a properly configured drill guide 104 according to the implantation plan.

In some embodiments of the invention, top portion 402 is removable from the rest of drill guide manipulator 106 for sterilization and/or cleaning and/or maintenance.

Referring to FIG. 4B, the eccentric configuration of drill guide manipulator 106 is shown without the gearing, which is shown in FIG. 4C, in accordance with an exemplary embodiment of the invention. It can be seen that rotation of one or both of a first disc assembly 410 and a second disc assembly 412 will cause movement of manipulation rod 406, which is pivotably anchored on second disc assembly 412 and extends through first disc assembly 410, in an embodiment of the invention. In an embodiment of the invention, movement accuracy is better than 0.1 mm and 0.5° in the respective degrees of freedom. In some embodiments of the invention, the dynamic range of movement of manipulation rod 406 is +/−11 mm and +/−15°.

FIG. 4C shows a gear configuration which is adapted to cause rotation of first disc assembly 410 and/or second disc assembly 412 to impart movement to manipulation rod 406, in accordance with an exemplary embodiment of the invention. In an embodiment of the invention, a first disc assembly gear 414, connected to first disc assembly 410, is rotated by a first disc assembly shaft 416 which is in turn operatively connected to a motor (not shown) adapted for turning first disc assembly shaft 416. In an embodiment of the invention, second disc assembly 412 is provided with a second disc assembly gear 418 which is driven by a second disc assembly shaft 420, also operatively connected to a motor (not shown). Optionally, the motors used for driving first disc assembly shaft 416 and second disc assembly shaft 420 are the same motor. In some embodiments of the invention, a plenary-gear configuration is used since the eccentric gear's center is not in one constant place.

In some embodiments of the invention, manipulation rod 406 is provided with z axis motion 422 by moving the top portion 402, thereby shifting mounting seat 404 up and down relative to manipulation rod 406.

Optionally, movement to mounting rod 406 is achieved using x and y tables, for example as described in PCT Application No. PCT/IL2004/000069, the disclosure of which is incorporated herein by reference.

### Exemplary Methods of Using and Making

FIG. 6 is a flowchart 600 of a flexible method for providing at least one dental implant, in accordance with an exemplary embodiment of the invention. The method is conceived based on a scenario of a patient coming into a dentist's office requiring and/or wanting dental implants for providing improved oral function and/or aesthetics, however other scenarios may be addressed using the herein described methodology.

Upon the presentation of the patient at a dentist's office or clinic, the dentist decides approximately where implantation is to take place inside the patient's mouth. In an embodiment of the invention, the dentist takes (602) an impression of the patient's oral anatomy (e.g. teeth). Optionally, more than one impression is taken, for example upper jaw, lower jaw and/or bite are all impressions which could be taken (602) by the dentist. Using the impression(s) taken by the dentist at his office, a customized dental template, for example template 102 of FIG. 2A, is made (604) which takes into account the approximate location(s) of where implantation is to take place and/or which is adapted to seat stably on a plurality of oral structures in the patient's mouth. As described above, exposed implantation spaces 112 are provided to template 102 to take into account the approximate location(s) of where implantation is take place.

In an embodiment of the invention, the finished customized template is placed in the patient's mouth and is imaged (606) while stably seated on oral structures of the patient's anatomy. One reason for imaging (606) the patient's anatomy with the template in place is to allow for registration (608) of the template to the patient's anatomy. As described above, templates are provided with fiducial markers which appear in the images taken of the patient's anatomy fitted with the template. Using the knowledge of where specific fiducial markers are located on the template and where these specific fiducial markers appear in relation to the patient's anatomy, the template can be registered (608) with the anatomy, in accordance with embodiment of the invention. Registration (608) is optionally performed by software programmed controller 108.

Optionally, registration (608) can be performed without indexing fiducial markers located on the template to images of the patient's anatomy. For example, a surface matching methodology is optionally used additionally or alternatively to the above described method for registering (608) the template to the patient's anatomy. In accordance with a surface matching method embodiment, an image of the patient's anatomy is compared with an image of the customized template. Identification and correlation of specific surfaces on the template and in the patient's anatomy also provide a method of registration (606), one in which the patient's anatomy doesn't have to be scanned in conjunction with template 102, in some embodiments of the invention.

Using registration (608) information acquired or calculated as above in conjunction with the knowledge of where implantation will take place, the attending medical professional can create (610) an implantation plan whereby the template, the patient's anatomy and/or the implantation sites are plotted in one unified coordinate space. Optionally, to help in creating the implantation plan, contours of the scanned, registered dental impression are plotted, overlayed on x-ray data (for example, a CT scan) of the patient. These overlayed images optionally show cross-sections, and/or 3-D surfaces, of the dental impression, and cross-sections and/or segmented 3-D objects from a CT scan. Such overlayed images are potentially useful, for example, for knowing drilling depth when drilling through soft tissue without removing it. They may also be useful for identifying CT streaks, which are artifacts caused by nearby metal objects such as fillings, in the CT scan. An image of the dental impression may be used to remove artifacts from the CT scan, by comparing the impression, which does not exhibit the artifacts, with the CT scan.

In an embodiment of the invention, controller 108 calculates the proper position and/or orientation of at least one drill guide, for example drill guide 104, for guiding the medical professional's drill, for example drill bit 310, to perform implantation. Optionally, more than one drill guide configuration is calculated by controller 108. Optionally, more than one drill guide configuration is a part of a set of drill guide configurations, wherein the set of drill guide configurations are intended to be used in conjunction during the implantation procedure.

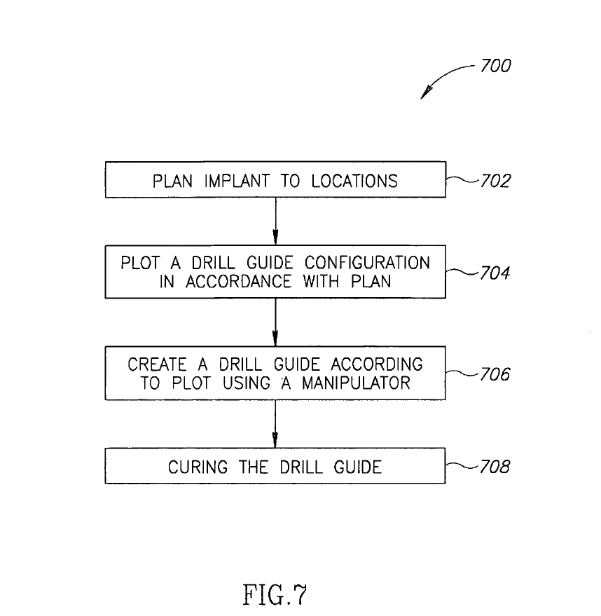

In an embodiment of the invention, drill guide manipulator 106 is used to manipulate (612) at least one drill guide into a calculated proper position and/or orientation for performing the implantation procedure according to the implantation plan. An exemplary method of manufacturing drill guides with drill guide manipulator 106 is described in more detail with respect to FIG. 7, below.

Properly configured drill guides are then mounted to the customized template prior to or during the implantation procedure, which the medical professional then uses to accurately implant (614) prosthetic teeth according to the implantation plan. In some embodiments of the invention, controller 108 indicates to the medical professional in which mounting slot 118 on template 102 drill guide 104 is to be placed.

In an embodiment of the invention, the medical professional is afforded the flexibility to exercise professional judgment to alter the implantation plan and/or to alter the devices (e.g. drill guides) which are to be used to carry out the plan. Examples of flexibility provided to the professional include being able to examine the patient's condition at the time of the procedure to determine if there is a reason why the implantation plan should be altered (reasons include bone regrowth after tooth extraction, initial plan was based on unclear images of patient's anatomy, soft tissue issues) and/or the ability to change drill guide configurations at the time of performing the procedure and/or at the medical professional's office and/or mounting locations on template 102 while still being able to use the same template.

For some dental procedures, in particular for procedures which take a relatively long time to perform, such as oral surgery, it may be advantageous to fasten the template to the patient's jaw, for example by one or more pins and/or screws, before using it to guide the procedure. Optionally, when the template is used in such a procedure, one or more preliminary guides are first used to guide the drilling of a hole for inserting a pin or screw into the jaw, with the pin or screw being inserted through the guide or not, and/or to guide the insertion of a screw into the jaw, with or without drilling a hole first. When these preliminary guides are used, the template is optionally held in place by hand. Using these preliminary guides has the potential advantage of ensuring that the template will be attached to the jaw at an attachment point that will not cause damage. Optionally, the preliminary guides are positioned over relatively small holes in the template, not shown in the drawings, designed for attaching the template to the jaw and positioned near the attachment point, and not over large openings such as implantation space 112.

Once the template has been attached to the jaw, one or more guides, generally positioned at a different location from the preliminary guides, are used to guide the oral surgery or other dental procedure. The procedure need not be an implant, but is optionally any dental procedure or surgery in which guides for drilling and/or cutting can be advantageously used.

FIG. 7 shows a flowchart 700 of a method for making at least one drill guide 104 suitable for use according to an implantation plan using drill guide manipulator 106, in accordance with an exemplary embodiment of the invention. As described above, initial actions are performed in order to determine the patient's anatomy, create a customized dental template and/or to determine the patient's anatomy in relation to the template. Optionally, these actions and/or the information determined by performing these actions is adapted to be manipulated and/or analyzed by controller 108.

Referring to FIG. 3B, which shows an exploded view of a drill guide, it can be seen that a drill guide is comprised of a plurality of components which are assembled before the drill guide is used according to the method described herein and with respect to FIG. 7. In an embodiment of the invention, a drill guide is at least partially comprised of a light curable resin which is used to set a properly configured drill guide once it has been manipulated for use according to an implantation plan. Using the light curable property of the drill guide, end seals of sheath section 302 (for sealing in spring 314 and/or resin inside a sheath 316 which encloses sheath section 302) can be formed during assembly with carefully directed light.

In an embodiment of the invention, a medical professional uses at least controller 108 to plan (702) an implantation procedure. Planning (702) involves indicating where on the patient's anatomy implantation is to take place factoring at least one of the medical professional's training, the needs/wants of the patient, the medical condition of the patient or the abilities of system 100, in an embodiment of the invention. In an exemplary embodiment of the invention, planning (702) also includes calculating (704) the proper position and/or orientation of at least one drill guide in order to carry out the implantation procedure according to the implantation plan. Drill guide orientation and/or position is calculated in relation to both template 102 and the patient's anatomy, in an embodiment of the invention.

An at least initially flexible, pre-configured drill guide 116 is placed onto manipulator 106 to create (706) a properly configured drill guide 104 which is suitable for use in the implantation procedure optionally according to the implantation plan. Manipulator 106 manipulates drill guide 116 in at least two degrees of freedom until it assumes the intended configuration, in an embodiment of the invention. Optionally, the medical professional is afforded the opportunity to make adjustments to the configuration of drill guide 116 via controller 108. Drill guide 116 is cured (708) to become substantially rigid once is has assumed the intended, proper configuration to create drill guide 104, in an embodiment of the invention. In some embodiments of the invention, drill guide 116 is cured by light. Optionally, the light is blue light, such as what is found at any typical dentist's office. Optionally, the light is ultraviolet. In an embodiment of the invention, the light curable resin within the drill guide is what provides rigidity to the drill guide once it has been cured.

In an embodiment of the invention, drill guides are manufactured, using manipulator 106, by the medical professional who will perform the implantation procedure and/or are manufactured at the site where the implantation procedure will be performed.

The present invention has been described using non-limiting detailed descriptions of embodiments thereof that are provided by way of example and are not intended to limit the scope of the invention. It should be understood that features and/or steps described with respect to one embodiment may be used with other embodiments and that not all embodiments of the invention have all of the features and/or steps shown in a particular figure or described with respect to one of the embodiments. Variations of embodiments described will occur to persons of the art. Furthermore, the terms “comprise,” “include,” “have” and their conjugates, shall mean, when used in the disclosure and/or claims, “including but not necessarily limited to.”

It is noted that some of the above described embodiments may describe the best mode contemplated by the inventors and therefore may include structure, acts or details of structures and acts that may not be essential to the invention and which are described as examples. Structure and acts described herein are replaceable by equivalents, which perform the same function, even if the structure or acts are different, as known in the art. Therefore, the scope of the invention is limited only by the elements and limitations as used in the claims.

1. A template for performing a dental implantation procedure, comprising:
a main body adapted to seat on a plurality of oral structures; and
at least one mounting point on the main body for mounting at least one drill guide;
wherein the main body is provided with at least one exposed implantation space where the dental implantation is to be performed.

2. A template according to claim 1, wherein the at least mounting point comprises a mounting slot.

3. A system for performing a dental implantation procedure, comprising:
a dental template according to claim 1; and
a drill guide, adapted to mount to the mounting point such that the drill guide will be at a fixed position and orientation relative to the template;
wherein the drill guide is capable of being adjusted to determine said position, orientation, or both.

4. A template according to claim 1, wherein said at least one mounting point comprises a plurality of mounting points.

5. A template according to claim 1, wherein the oral structures are at least one of a tooth, soft tissue or a healing cap.

6. A template according to claim 1, further comprising a connecting structure on which at least one mounting point for at least one drill guide is located.

7. A template according to claim 6, wherein the connecting structure is provided with at least one fiducial marker location.

8. A template according to claim 1, wherein the at least one drill guide mounts on the bottom of the template.

9. A template according to claim 1, wherein at least the main body is rapidly prototyped.

10. A template according to claim 1, further comprising at least one fiducial marker detectable in a medical imaging scan.

11. A template according to claim 10, wherein the at least one fiducial marker is comprised of aluminum oxide.

12. A template according to claim 1, further comprising a prosthetic mounting structure adapted to removably attach to the main body for showing a potential result of the dental implantation procedure.

13. A template according to claim 12, wherein a prosthetic is a tooth.

14. A template according to claim 3, further comprising at least one code type to indicate in which mounting point the at least one drill guide should be placed.

15. A template according to claim 14, wherein a code type is color.

16. A template according to claim 14, wherein a code type is a number.

17. A template according to claim 14, wherein a code type is shape.

18. A template according to claim 1, wherein the at least one drill guide is mounted to the side of the at least one exposed implantation space.

19. A template according to claim 1, wherein the at least one drill guide is adapted for performing a sinus incision.

20. A template according to claim 1, wherein the at least one drill guide is adapted for performing the attachment of the template to the jaw.

21. A drill guide for performing a dental implantation procedure, comprising:
a mounting section adapted for removably mounting the drill guide to at least one of a dental template or dental guide manipulator;
a guide section adapted for passage therethrough of a drill bit; and,
a selectively flexible or rigid arm configurable with at least one of a proper position or orientation by the dental guide manipulator for performing the dental implantation procedure.

22. A drill guide according to claim 21, wherein the selectively flexible arm is comprised of woven, braided or knit fibers.

23. A drill guide according to claim 21, wherein the selectively flexible arm is comprised of a light curable resin.

24. A drill guide according to claim 23, wherein the light curable resin is curable by at least one of blue light or ultraviolet light.

25. A drill guide according to claim 21, wherein the drill guide is selected to be flexible prior to the dental implantation procedure and is selected to be rigid during the implantation procedure.

26. A drill guide according to claim 21, wherein the drill guide is one of a plurality of differently configured drill guides forming a set of drill guides.

27. A drill guide according to claim 21, wherein the guide section accommodates each of a plurality of different sleeves for guiding drills of different diameter and/or shape.

28. A drill guide according to claim 27, wherein at least one of the sleeves fits inside another one of the sleeves.

29. A drill guide according to claim 28, wherein a first one of the sleeves is removable only from a first side of the drill guide, and a second one of the sleeves, which fits inside the first one of the sleeves, is removable only from a second side of the drill guide, opposite to the first side.

30. A drill guide according to claim 21, further comprising a code type tag used for mounting the drill guide to the dental template in a correct position.

31. A drill guide manipulator for manipulating drill guides to be used in a dental implantation procedure, comprising:
at least one mounting seat provided to a top portion of the drill guide manipulator and adapted to mate with a mounting section of a drill guide;
a manipulator rod adapted to mate with a guide section of the drill guide;
an eccentric gear configuration for providing movement to the manipulator rod; and
wherein movement of the manipulator rod with respect to the at least one mounting seat provides movement to the drill guide in at least two degrees of freedom.

32. A drill guide manipulator according to claim 31, further comprising at least one indicator associated with the at least one mounting seat for indicating the drill guide should be mated to the mounting seat.

33. A drill guide manipulator according to claim 31, wherein the top portion is removable from the drill guide manipulator for at least one of cleaning, sterilization or maintenance.

34. A drill guide manipulator according to claim 31, provided with operative communication to a controller.

35. A system for performing a dental implantation procedure, comprising:
a dental template;
a software programmed controller adapted to register the dental template to a patient's anatomy and calculate a dental implantation plan which includes at least one drill guide configuration in accordance with the plan;
at least one selectively flexible drill guide manipulated into the configuration in accordance with the plan and removably attached to the dental template; and,
a drill guide manipulator adapted to manipulate the at least one drill guide into the configuration in accordance with the plan using an eccentric gear configuration.

36. A system according to claim 35, wherein the dental template is provided with at least one exposed implantation space proximal to where the dental implantation procedure is to take place.

37. A system according to claim 35, wherein the drill guide manipulator is adapted to manipulate the at least one drill guide in at least 2 degrees of freedom.

38. A system according to claim 35, wherein the drill guide manipulator manipulates in response to commands received from the controller.

39. A method of performing a dental implantation procedure, comprising:
making a customized dental template of a patient's anatomy;
registering the template with the patient's anatomy, using an image of the patient's anatomy;
calculating an implantation plan including at least one proper drill guide configuration relative to the template, in accordance with the implantation plan;
creating at least one drill guide so that it will be in the proper drill guide configuration when it is attached to the template, in accordance with the implantation plan using a drill guide manipulator adapted to manipulate the at least drill guide in at least two degrees of freedom;
attaching the drill guide to the template such that the drill guide will be in the proper drill guide configuration relative to the template, and relative to the patient's anatomy when the template is registered; and,
implanting at least one dental implant using the at least one drill guide, when the drill guide is attached and the template is registered.

40. A method according to claim 39, wherein the customized dental template is made according to a dental impression of the patient's anatomy.

41. A method according to claim 39, wherein the customized dental template is made according to a scanned image of the patient's anatomy.

42. A method according to claim 39, wherein the customized dental template is made using rapid prototyping techniques.

43. A method according to claim 39, wherein calculating is performed by a software programmed controller.

44. A method according to claim 43, wherein the controller commands the drill guide manipulator to manipulate according to the implantation plan.

45. A method according to claim 39, wherein registering is performed by matching surfaces of the dental template and the patient's anatomy.

46. A method according to claim 39, wherein registering is performed using fiducial markers located in the dental template.

47. A method according to claim 39, wherein creating commences with an initially flexible drill guide and ends with a substantially rigid drill guide.

48. A method according to claim 47, wherein the drill guide is cured using at least one of blue light or ultraviolet light.

49. A method according to claim 39, wherein making a customized dental template comprises making a template of the upper jaw, a template of the lower jaw, and a bite template, registering the template to the patient's anatomy comprises registering the upper jaw template relative to the lower jaw template using the bite template, thereby obtaining occlusion information, and calculating an implantation plan comprises using the occlusion information.

50. A method according to claim 39, wherein calculating an implantation plan comprises using an image of the template overlayed on an image of the patient's anatomy.

51. A method of making at least one drill guide using a drill guide manipulator, comprising:
planning implant locations using a previously acquired image of a patient's anatomy and a software programmed controller;
plotting at least one of position or orientation of the at least one drill guide based on the planned implant locations;
using an eccentric gear configured drill guide manipulator to create the at least one drill guide according to at least one of plotted position or orientation received from the controller; and,
curing the at least one drill guide to make it substantially rigid.

52. A method according to claim 51, wherein curing is performed by at least one of blue light or ultraviolet light.

53. A method according to claim 51, wherein using the drill guide manipulator includes choosing a mounting seat from a plurality of mounting seats for creating the at least one drill guide.

54. A method according to claim 53, wherein the mounting seat to be chosen is indicated by an indicator.
